(19) United States
(12) Patent Application Publication
(10) Pub. No.: US 2026/0267911 A1
(43) Pub. Date: Sep. 10, 2026

(54) LOCATION-SPECIFIC IMAGE COLLECTION

(71) Applicant: GRABTAXI HOLDINGS PTE. LTD., Singapore (SG)

(72) Inventors: Zhixin YU, Chaoyang District, Beijing (CN); Shuangquan HOU, Chaoyang District, Beijing (CN); Chen LIANG, Singapore (SG); Shiqian WANG, Shenzhen, Guangdong (CN)

(21) Appl. No.: 18/994,878

(22) PCT Filed: Aug. 18, 2023
(86) PCT No.: PCT/SG2023/050572

§ 371 Date: Jan. 15, 2025

(30) Foreign Application Priority Data
Aug. 19, 2022 (WO) PCT/CN2022/113573

(51) Int. Cl. G06F 16/587; G01C 11/06; G06F 16/55; G06T 7/00; G06V 10/74; G06V 10/762; G06V 10/94; G06V 20/56; H04N 7/18

(52) U.S. Cl. CPC G06F 16/587; G01C 11/06; G06F 16/55; G06T 7/0002; G06V 10/761; G06V 10/762; G06V 10/95; G06V 20/56; H04N 7/181; H04N 7/188; G06T 2207/30168; G06T 2207/30252

(57) ABSTRACT

An edge device and method for image capture and processing, wherein captured images are processed to obtain location representative image set, the location representative image set and GPS location data associated with the location representative image set are transmitted to a remote server. Processing the captured images comprises performing object detection on the images to detect one or more location markers and the location representative image set is based on the images wherein the one or more location markers are detected.

### TECHNICAL FIELD

This disclosure generally relates to location-specific image collection systems including edge devices and methods of location-specific image collection.

### BACKGROUND

This background description is provided for the purpose of generally presenting the context of the disclosure. Contents of this background section are neither expressly nor impliedly admitted as prior art against the present disclosure.

Locating a person or a machine in an urban environment involves referencing recognizable location-specific objects such as a street sign or a shopfront or a location marker. Recognizable location-specific objects provide an added layer of certainty in locating a person or a machine in an urban environment. However, most large cities have sprawling streetscapes stretching for several 100s of kilometres. An image-based map of the streetscapes of any sizeable city requires a huge volume of image data. In addition, the streetscapes of most cities are also dynamic. By some estimates, roughly 10% to 30% of the streetscapes of cities change every year. Thus while the collection of baseline streetscape image data is a computational challenge in itself, the frequent updates necessary to keep the collected data presents an additional computational challenge on top of the baseline data collection. Vans or vehicles such as the Google Street View car are specifically designed and equipped to capture images. However, such designated vehicle-based approaches are not scalable for streetscapes that change frequently and in circumstances where the access to network communication bandwidth is limited. Such designated vehicle-based approaches are also capital intensive as the vehicles are fitted with complex imaging and communication machinery to capture, store and transmit images.

It is desired to address or ameliorate one or more disadvantages or limitations associated with the prior art, or to at least provide a useful alternative.

### SUMMARY

In one embodiment, the present disclosure provides an edge device for image capture and processing, the edge device comprising: one or more cameras (camera(s)); a GPS device; one or more processors (processor(s)); a network interface for enabling communication between the edge device and a remote server; a memory accessible to the processor(s), the memory comprising program code executable by the processor(s) to: trigger capture of images by the camera(s); process the captured images to obtain location representative image set; and transmit the location representative image set and GPS location data associated with the location representative image set to the remote server through the network interface; wherein processing the captured images comprises performing object detection on the images to detect one or more location markers; and the location representative image set is based on the images wherein the one or more location markers are detected.

The present disclosure also provides an edge device for image capture and processing, the edge device comprising: one or more processors (processor(s)); one or more cameras (camera(s)); a GPS device; an inertial measurement unit (IMU); a network interface for enabling communication between the edge device and a remote server; a memory accessible to the processor(s), the memory comprising program code executable by the processor(s) to: in response to a signal from the IMU or the GPS device indicating movement of the edge device, trigger the capture of images by the camera(s); process the captured images to determine a quality metric for each of the captured images; discard images with a quality metric below a predefined image quality threshold to obtain a first refined image set; perform object detection on the first refined image set to detect one or more location markers in the images of the first refined image set; discard images not including location markers in the first refined image set to obtain a second refined image set; perform similarity analysis of the images in the second refined image set to identify clusters of similar images; select a representative image from each cluster of similar images to obtain a location representative image set; transmit the location representative image set and GPS data associated with the representative images to the remote server.

The present disclosure also provides a method for image capture and processing, the method comprising providing an edge device for image capture and processing, the edge device comprising: one or more processors (processor(s)), one or more cameras (camera(s)), a GPS device, an inertial measurement unit (IMU), a network interface for enabling communication between the edge device and a remote server; a memory accessible to the processor(s); in response to a signal from the IMU or the GPS device indicating movement of the edge device, triggering the capture of images by the camera(s); processing the captured images to determine a quality metric for the images; discarding images with a quality metric below a predefined image quality threshold to obtain a first refined image set; performing object detection on the first refined image set to detect one or more location markers in the images of the first refined image set; discarding images not including location markers in the first refined image set to obtain a second refined image set; performing similarity analysis of the images in the second refined image set to identify clusters of similar images; selecting a representative image from each cluster of similar images to obtain a location representative image set; and transmitting the location representative image set and GPS data associated with the representative images to the remote server.

The present disclosure also provides a method of image capture and processing, the method comprising: providing an edge device comprising: one or more cameras (camera(s)), a GPS device, one or more processors (processor(s)), network interface device; triggering capturing one or more images (image(s)) by the camera(s); processing the captured image(s) to obtain location representative image set; and transmitting the location representative image set and location data captured by the GPS data to a remote server through the network interface device; wherein processing the captured images comprises performing object detection on the images to detect one or more location markers; and the location representative image set is based on the images wherein the one or more location markers are detected.

### BRIEF DESCRIPTION OF THE DRAWINGS

Exemplary embodiments of the present invention are illustrated by way of example in the accompanying drawings in which like reference numbers indicate the same or similar elements and in which:

FIG. 1 illustrates a system for location-specific image collection that comprises a plurality of edge devices;

FIG. 2 illustrates a method of image processing executable by the edge device;

FIG. 3 illustrates an overall development and operations framework for the system for image data collection;

FIG. 4 is a block diagram illustrating some of the steps of the method of image collection; and

FIG. 5 illustrates an image capture and processing workflow executed by the edge device.

### DETAILED DESCRIPTION

The disclosure provides edge devices that allow the efficient capture and transmission of imagery to enable map creation or to augment mapping and navigation systems with location-specific imagery. Environments such as urban environments have several location-specific fixtures or objects that indicate location. For example, a specific street sign or a combination of street signs indicates the location of a place by reference to the name of the street/streets in the street signage. Alternatively, an iconic building or an iconic storefront has its own distinctive recognizable appearance that conveys location. An individual with knowledge of the iconic storefront or building may easily locate themselves when they are in its vicinity. In this context, the word “iconic” includes within its scope that something can be recognized to the exclusion of all other things in its area -for example, a storefront that is unique in its area can provide accurate information about the relative position of a person, camera or other image capture device viewing that storefront. While a formal addressing system or a combination of longitude and latitude coordinates may designate the locations, individuals often locate themselves by reference to more recognizable objects or signs which may be collectively referred to as location markers or points of interest.

Locating oneself with the assistance of a location marker such as an image of a recognizable location is often more intuitive and efficient for individuals. However, cataloguing and the collection of such imagery presents a significant computational challenge. Several factors make cataloguing and collection of such imagery a significant computational challenge. High-resolution images are often required to provide meaningful visual map-making capabilities. With sprawling urban areas, capturing high-resolution images of such areas requires the handling and processing of a large volume of image data. In addition, the streetscapes of urban areas change over time. A sign or a location marker that may have been meaningful for locating oneself at a particular point in time may be removed or replaced. Similarly, new location-specific markers or signs may be erected that need to be taken into account for visual map-making and location operations. In addition, the large volume of image data requires location-specific annotation to enable the integration of the captured images with a map-making or a map-based navigation application.

The edge devices and methods of this disclosure address some of the above noted computational challenges by capturing and processing images through the edge device. The edge devices also perform specific image processing operations to reduce the volume of image data for visual map creation applications and visual map refreshing operations. The image processing operations include a combination of one or more of: image quality detection, object detection, image similarity analysis, image clustering, trigger specific image capture and data compression. Edge devices taught herein may also reject images where another image is a more suitable, clearer or more accurate reflection of a user's or driver's location.

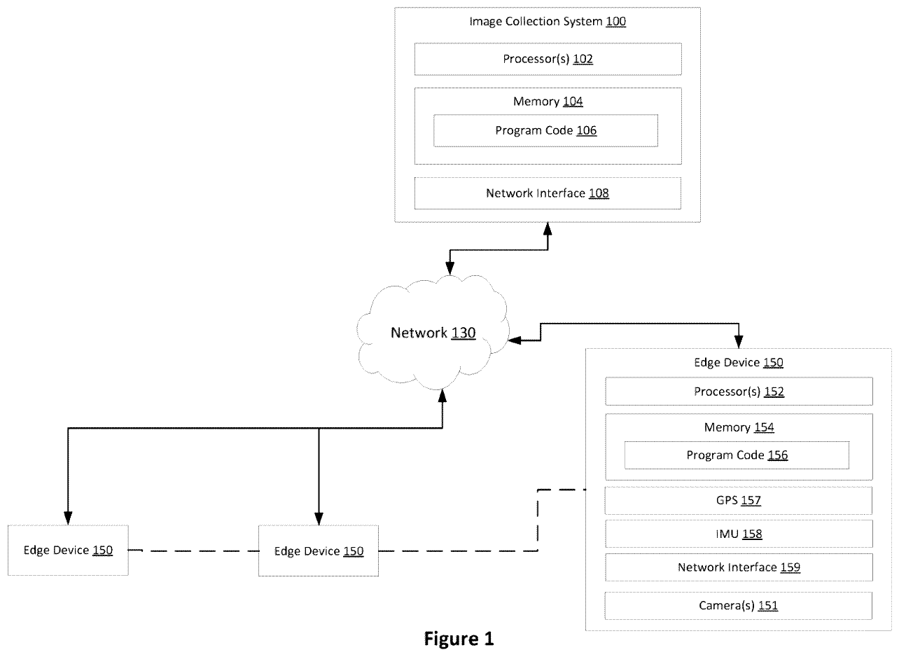

FIG. 1 illustrates a system for location-specific image collection that comprises a plurality of edge devices 150. The edge devices are in communication with an image collection system 100 (also referred to as a remote server). The image collection system 100 comprises at least one processor 102, a memory 104 and a network interface 108. The memory 104 comprises program code 106 to execute operations and interact with the plurality of edge devices 150. The network interface 108 allows or enables communication between the image collection system 100 and other devices such as edge devices 150 over a communication network 130. The processor(s) 102 may be any suitable processor for performing the operations set out below for the image collection system 100.

Edge device 150 comprises one or more processors 152, memory 154 accessible to the processor(s), a Global Positioning System (GPS) device 157, an inertial measurement unit (IMU) 158 and a network interface 159. The processors 152 and also processors 102 may be any suitable device such as a central processing unit, graphics processing unit or other device. The network interface 159 allows or enables communication between the edge device 150 and other devices such as the image collection system 100 over a communication network 130. Program code 156 is provided in memory 154 to perform the image processing operations of the edge device. The edge devices comprise or are connected to one or more image capture devices, presently embodied by camera or cameras 151, to capture images. In some embodiments, camera 151 may capture images of size 3-5 MB for a 150° field of view and images of size 10-12 MB for a 360° field of view. The camera 151 may take 1 image every predetermined period—e.g. every second—or one image every predetermined distance of travel—e.g. 5 meters of travel.

In some embodiments, the edge device 150 may be mounted on a helmet of a driver of a vehicle with the camera 151 capturing images of the vicinity of the driver as the driver navigates. This can be useful since, as the driver turns their head, the camera 151 captures a field of viewing corresponding to that of the driver, or corresponding in substance sufficient for the present teachings to apply. Alternatively, the edge device 150 may be mounted on a vehicle with camera 151 configured to capture images as the vehicle navigates. In embodiments comprising multiple cameras 151, the cameras 151 may be so arranged to capture images from different directions, locations or angles with respect to the edge device. The network interface 159 of the edge device allows wireless communication with a cellular network such as a 4G or a 5G network 130.

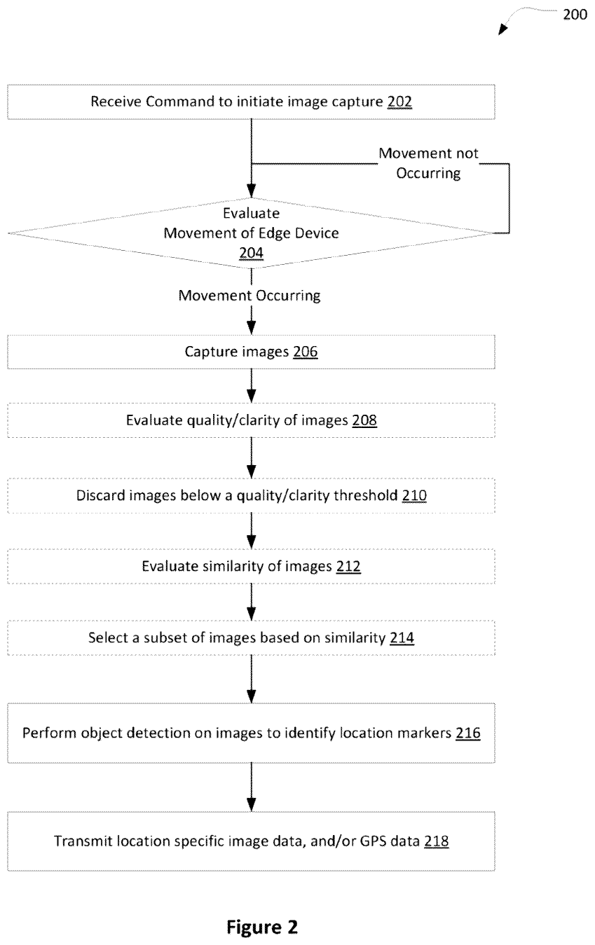

FIG. 2 illustrates a method 200 of image processing executable by the edge device 150. Various steps of method 200 may be altered or varied by the embodiments in practice to suit particular imaging conditions or edge device architectures. In some embodiments, one or more steps of method 200 may be skipped or not performed to suit the imaging conditions or computational architecture in place. In some embodiments, the order of the various steps of method 200 may be varied to suit the imaging conditions or computational architecture in place.

At step 202, the edge device 150 receives a command from the image collection system 100 to initiate the capture of images. The command may be issued in response to the edge device 150 being in a particular location or a particular geo-fenced location earmarked for image collection. The memory 154 of the edge device may comprise geo-fence data. The geo-fence data may define the boundaries or regions earmarked for image capture. The edge device may determine that it is present in a geo-fenced area based the geo-fence data and data from the GPS device. On determining that the edge device is located in the geo-fenced area, the edge device may trigger the capture of images. Geo-fence based image collection further reduces the volume of image data being collected and enables the focus of image data collection in specific regions that may have been previously poorly mapped or in regions with outdated image maps.

The command may be issued in response to a driver flagging (e.g. through a touchscreen interface of their mobile device) that images should now be collected. The image collection system 100 may define an image collection schedule or plan and on receiving an indication from an edge device 150 being located in a location earmarked for image collection or a refresh of images previously collected from the earmarked location, may issue the command to the edge device 150.

At step 204, the edge device 150 evaluates whether the physical movement of the edge device 150 is occurring. The occurrence of the movement may be evaluated based on data from one or both of the IMU and the GPS device of the edge device 150, or GPS of the driver's vehicle. In previous technologies, an edge device may be steady and not moving. Capturing images while the edge device is steady and not moving may not provide informative images for map-making purposes. In addition, capturing images unnecessarily will drain the limited power and network bandwidth resources available to the edge device 150. If no movement is detected, then the edge device 150 remains in an idle state awaiting the occurrence of movement. For example, if the edge device 150 is worn as part of a helmet by a driver of a vehicle, while the vehicle is still at a red light in traffic, image capture is stopped to reduce the amount of image data that needs to be processed.

If movement is detected, the edge device 150 captures images at step 206. The images are captured as a stream of images or in video form. In addition to the capture of images, at the time at which an image is captured the GPS-based location coordinates of the edge device may also be captured and associated with the respective captured image. The GPS data allows subsequent allocation of the captured images to a map during map-making operations. To that end, the process 200 may involve allocating or associating images with locations on a map corresponding to where the respective images where captured.

At 208, the edge device 150 processes the images captured at 206 to evaluate the quality or clarity of the images. Image quality may be evaluated based on measures such as Mean Square Error, Peak Signal to Noise Ratio, Universal Image Quality Index, Structural SIMilarity, Feature SIMilarity, Gradient Similarity measure, Noise Quality Measure or other similar or alternative image quality measures. Based on the image quality metrics evaluated at step 208, images that fall below a predefined quality threshold are discarded at step 210. The discarding of low-quality images reduces the computational and data volume burden on the edge device. Low-quality images are not suitable for map-making operations and may provide less actionable information in the subsequent steps of method 200.

At step 212, the similarity of the various images is evaluated. As one overall objective of method 200 is to reduce the volume of image data, the collection of several images that are similar or capture similar location markers would increase the volume of image data. Thus at step 212, the similarity of the remaining images after step 210 is evaluated to identify one or more clusters of images, wherein each cluster of images may comprise one or more common location markers or points of interest. Various image similarity measures may be incorporated at step 212 including evaluating image similarity using a Siamese Network, or using Minkowski distance, the Manhattan distance, the Euclidean distance and the Hausdorff distance etc. Based on the similarity measures, one or more clusters of images are identified, wherein each cluster of images represents a common set of one or more location markers. In some embodiments, the image similarity evaluation is performed for images captured over a predefined period. The predefined period may include a time window of: 15 seconds, or 30 seconds, or 45 seconds, or 60 seconds, or 75 seconds, or 90 seconds, or 105 seconds, or 120 seconds. In other embodiments, or in addition, the image similarity evaluation is performed for images captured within a predefine distance of each other as determined by measurements from the IMU and/or GPS. The predefined distance may be 5 m, 10 m, 15 m or other distance.

At step 214, a subset of images is selected by the edge device based on the results of the similarity analysis at step 212. For example, at least one image is selected from each cluster of images identified at step 212. By selecting one representative image, the meaningful location-related information (location markers or points of interest) in each cluster is selected. By doing so, the rest of the images of each of the cluster of images are discarded to significantly reduce the volume of image data.

At step 216, object detection operations are performed on the images selected at step 214. Object detection involves detecting instances of location markers from one or several classes of location markers in the images. The classes of location markers include traffic signs, named storefronts, street signs, landmarks and other recognizable location-specific points of interest. Images that do not comprise location markers are discarded at step 216 to further narrow the set of images and consequently reduce the image data volume.

At step 218, the images narrowed down at step 216 and the respective GPS location data associated with the images is transmitted to the image collection system 100. In some embodiments, the images are transformed into a video format and/or compressed using conventional compression technology to further reduce the volume of image data being transmitted. The video may be a video with 10 fps, 30 fps, 60 fps, etc and video compression techniques such as H.265, AV1 etc. may be used to compress the video before transmission.

Method 200 may be performed by an edge device at a designated frequency or over a designated period defined by the image collection system 100. The image collection system 100 has access to the location of the edge devices 150 and it may trigger method 200 when an edge device 150 enters a region that requires a refresh of location-specific image data or for which insufficient data has been captured. For example, the refresh of location-specific image data may be performed every 2-3 months for a region. The image collection system 100 also has access to a plurality of edge devices and it may accordingly collect and/or corrdinate collection of data from a plurality of edge devices travelling over a region to get an optimum degree of coverage for map-making purposes.

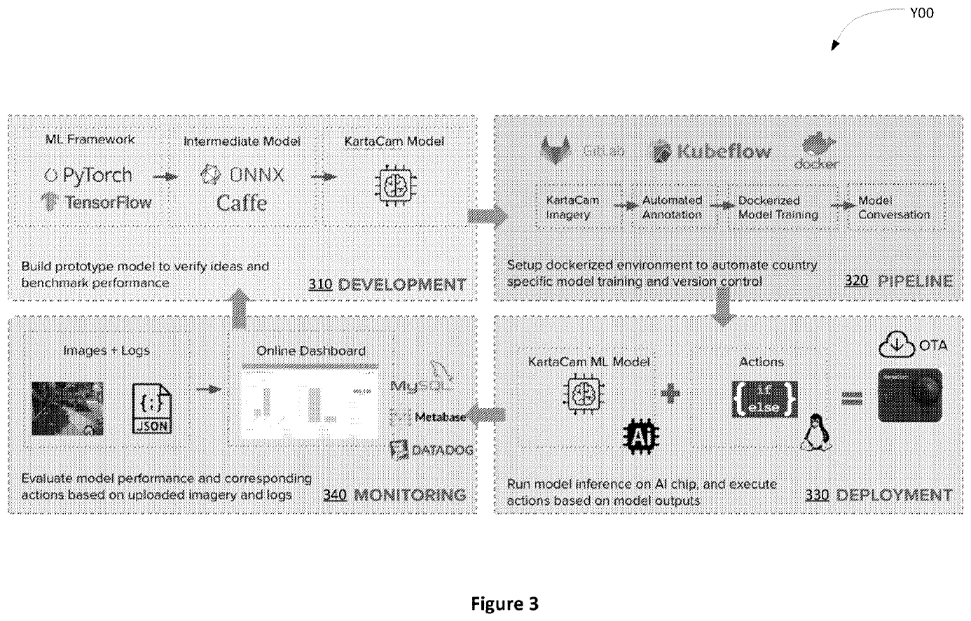

FIG. 3 illustrates an overall development and operations framework for the system for image data collection. Development stage 310 comprises designing of a machine learning (ML) framework for method 200. The ML framework is transformed into an intermediate mode followed by a model suitable for subsequent deployment (KartaCam Model). Pipeline stage 320 comprises fragmentation and version control of the KartaCam Model into separate environments, wherein each environment may be targeted to a specific region such as a country or a city. At stage 330, the various models in pipeline 320 are deployed and executed to collect image data through the edge or end devices 150. The collected image data is monitored at the monitoring stage 340 and learning from the monitoring stage is implemented to further refine the development stage 310 to better meet the needs of the overall image collection framework.

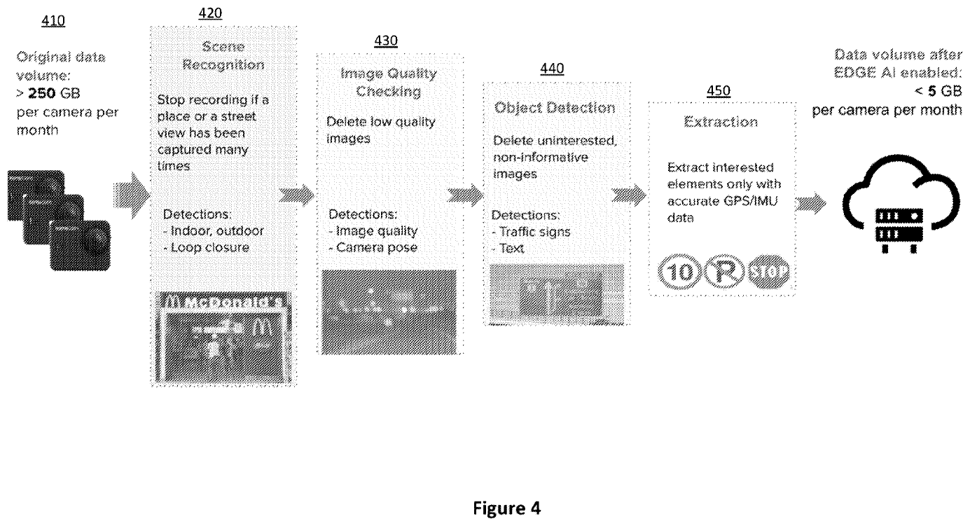

FIG. 4 is a block diagram illustrating some of the steps of method 200 of image collection. FIG. 4 also illustrates the progressive reduction in the volume of data by the steps of method 200. At step 410, the original image data volume of greater than 250 GB per camera per month is captured by an edge device 150. At step 420, the image capture is stopped for locations that may have been captured before. This stopping of image capture may be performed based on the similarity analysis operations of step 212 of method 200. Notably, many drivers frequently drive over a particular area. If that particular area has been adequately captured, then images from those drivers in those particular areas do not need to be captured, or at least may be captured far less frequently. At step 430, the image quality check operations (step 208 of method 200) are performed. The images of a quality metric below a predefined threshold are discarded. At step 440, object detection operations to detect images with location markers are performed (step 216 of method 200). This operation further allows the discarding of images without location markers. At step 450, images with accurate GPS data are extracted to further narrow down the total image data. In an exemplary embodiment, the 250 GB of data per camera per month, is reduced to less than 5 GB of data per month. This reduction of image data while retention of location-specific image data provides a significant reduction in the network bandwidth consumed by the edge device 150. The reduction in image data volume also simplified the downstream image data analysis and map-making operations performed by the image data collection system 100 or other systems that process the image data.

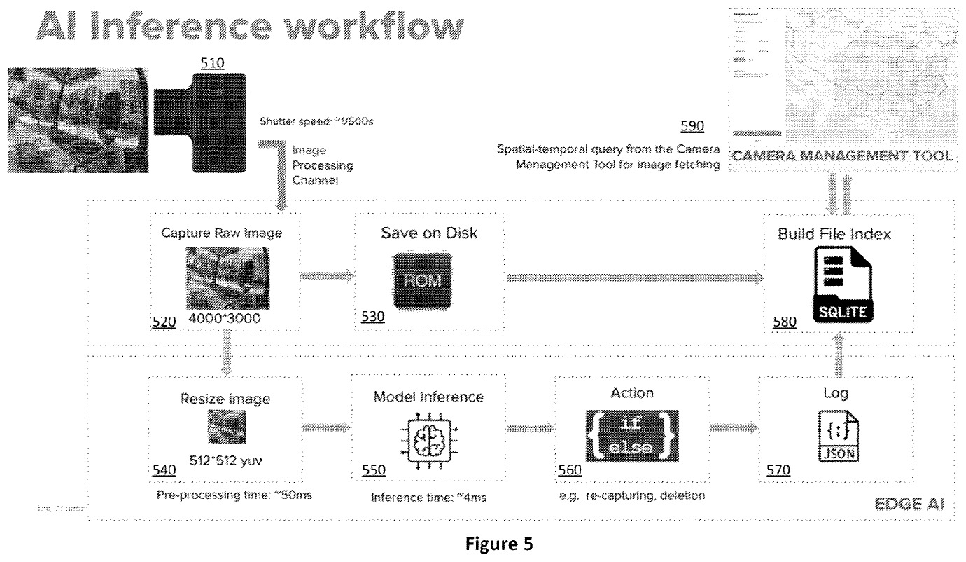

FIG. 5 illustrates an image capture and processing workflow executed by an edge device 150. At step 510, images are captured by the camera associated with the edge device. The captured raw image 520 is saved on the memory of the edge device at step 530. A resized version 540 of the image captured image 520 is processed by an image processing model 550 provided in the memory of the edge device. The model 550 may perform one or more operations of method 200 of FIG. 2. Model 550 generates inferences (for example: quality metrics, object detection etc.)—e.g. clarity (this can be detected by processing the image to determined if sharp gradient features exist, indicating accurate lines and, if none or few exist then the image is unclear), whether any location markers or points of interest are reflected in the image, if an obstruction (e.g. a truck travelling next to the driver) obscures the image, if there is insufficient lighting and so on. Based on the inferences of the model, at step 560 the edge computing device takes specific actions such as discarding images etc. The results of the inferences are stored in the memory of the edge device, including the GPS location data or GPS data for imagers that are not discarded or those that are selected. Based on the outcome of the inferences, a file index of the selected images is built at step 580. The file index is transmitted to the image collection system 100 for subsequent integration with a map-making tool to support spatial-temporal queries relating to location-specific imagery.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Although this disclosure describes or illustrates particular embodiments as providing particular advantages, particular embodiments may provide none, some, or all of these advantages.

1. An edge device for image capture and processing, the edge device comprising:
one or more processors (processor(s));
one or more cameras (camera(s));
a GPS device;
an inertial measurement unit (IMU);
a network interface for enabling communication between the edge device and a remote server;
a memory accessible to the processor(s), the memory comprising program code executable by the processor(s) to:
in response to a signal from the IMU or the GPS device indicating movement of the edge device, trigger the capture of images by the camera(s); process the captured images to determine a quality metric for each of the captured images;
discard images with a quality metric below a predefined image quality threshold to obtain a first refined image set;
perform object detection on the first refined image set to detect one or more location markers in the images of the first refined image set; discard images not including location markers in the first refined image set to obtain a second refined image set;
perform similarity analysis of the images in the second refined image set to identify clusters of similar images;
select a representative image from each cluster of similar images to obtain a location representative image set;
transmit the location representative image set and GPS data associated with the representative images to the remote server.

2. An edge device for image capture and processing, the edge device comprising:
one or more cameras (camera(s));
a GPS device;
one or more processors (processor(s));
a network interface for enabling communication between the edge device and a remote server;
a memory accessible to the processor(s), the memory comprising program code executable by the processor(s) to:
trigger capture of images by the camera(s);
process the captured images to obtain location representative image set; and
transmit the location representative image set and GPS location data associated with the location representative image set to the remote server through the network interface;
wherein processing the captured images comprises performing object detection on the images to detect one or more location markers; and the location representative image set is based on the images wherein the one or more location markers are detected.

3. The edge device of claim 2, wherein processing the captured images comprises: determination of a quality metric for each of the images; and
processing only the images with a quality metric above a predefined quality threshold to obtain the location representative image set.

4. The edge device of claim 1, wherein the location markers comprise one or more of: traffic signs, named storefronts, street signs, landmarks.

5. The edge device of claim 2, wherein processing the captured images comprises:
performing a similarity analysis of the captured images to identify clusters of similar images;
selecting a representative image from each cluster of similar images; and the location representative image set is obtained based on a representative image from each cluster of similar images.

6. The edge device of claim 1, wherein the similarity analysis is performed for images captured over a predefined time window;
optionally wherein the predefined time window is any one of: 15 seconds, or 30 seconds, or 45 seconds, or 60 seconds, or 75 seconds, or 90 seconds, or 105 seconds, or 120 seconds.

7. The edge device of claim 2, wherein the edge device further comprises an inertial measurement unit (IMU) and the capturing of images is triggered on detection of motion by the IMU.

8. The edge device of claim 1, wherein the location representative image set is compressed before transmission.

9. The edge device of claim 1, wherein the location representative image set is transformed into a compressed video before transmission.

10. The edge device of claim 1, wherein the edge device is mounted on a helmet to capture images as the helmet wearer navigates an area.

11. The edge device of claim 1, wherein the network interface comprises a cellular network radio device for transmission of signals over a cellular network.

12. The edge device of claim 1, wherein the memory comprises geofence data and the processor(s) is configured to:
determine presence of the edge device in a geo-fenced area based on the comprises geo-fence data and data from the GPS device; and
trigger the capture of images in response to determining that the edge device is present in a geo-fenced area.

13. A method for image capture and processing, the method comprising providing an edge device for image capture and processing, the edge device comprising:
one or more processors (processor(s)), one or more cameras (camera(s)), a GPS device, an inertial measurement unit (IMU), a network interface for enabling communication between the edge device and a remote server; a memory accessible to the processor(s);
in response to a signal from the IMU or the GPS device indicating movement of the edge device, triggering the capture of images by the camera(s); processing the captured images to determine a quality metric for the images; discarding images with a quality metric below a predefined image quality threshold to obtain a first refined image set;
performing object detection on the first refined image set to detect one or more location markers in the images of the first refined image set;
discarding images not including location markers in the first refined image set to obtain a second refined image set;
performing similarity analysis of the images in the second refined image set to identify clusters of similar images;
selecting a representative image from each cluster of similar images to obtain a location representative image set; and
transmitting the location representative image set and GPS data associated with the representative images to the remote server.

14. A method of image capture and processing, the method comprising:
providing an edge device comprising: one or more cameras (camera(s)), a GPS device, one or more processors (processor(s)), network interface device;
triggering capturing one or more images (image(s)) by the camera(s); processing the captured image(s) to obtain location representative image set; and transmitting the location representative image set and location data captured by the GPS data to a remote server through the network interface device; wherein processing the captured images comprises performing object detection on the images to detect one or more location markers; and
the location representative image set is based on the images wherein the one or more location markers are detected.

15. The method of claim 14, wherein processing the captured images comprises:
determination of a quality metric for each of the images; and processing only the images with a quality metric above a predefined quality threshold to obtain the location representative image set.

16. The method of claim 13, wherein the location markers comprise one or more of: traffic signs, named storefronts, street signs, landmarks.

17. The method of claim 14, wherein processing the captured images comprises:
performing a similarity analysis of the captured images to identify clusters of similar images;
select a representative image from each cluster of similar images; and the location representative image set is obtained based on a representative image from each cluster of similar images.

18. The method of claim 13, wherein the similarity analysis is performed for images captured over a predefined time window;
optionally wherein the predefined time window is any one of: 15 seconds, or 30 seconds, or 45 seconds, or 60 seconds, or 75 seconds, or 90 seconds, or 105 seconds, or 120 seconds.

19. The method of claim 14, wherein the capturing of images is triggered on a signal from an IMU detection of motion of the end device.

20. One or more non-transitory computer-readable storage media storing instructions that when executed by one or more processors cause the one or more processors to perform the method of claim 13.
